(19) United States
(12) Patent Application Publication
(10) Pub. No.: US 2016/0017143 A1
(43) Pub. Date: Jan. 21, 2016

(54) GEL SEALING CORROSION PREVENTION TAPE

(71) Applicant: 3M INNOVATIVE PROPERTIES COMPANY, Saint Paul, MN (US)

(72) Inventor: Steven L. Falteisek, Hudson, WI (US)

(73) Assignee: 3M INNOVATIVE PROPERTIES COMPANY, Saint Paul, MN (US)

(21) Appl. No.: 14/773,199

(22) PCT Filed: Mar. 5, 2014
(86) PCT No.: PCT/US2014/020540

§ 371 Date: Sep. 4, 2015

Related U.S. Application Data
(60) Provisional application No. 61/774,850, filed on Mar. 8, 2013.

(51) Int. Cl. C08L 75/04; C08K 7/28; C08K 9/06; C08K 5/56; C08K 3/32

(52) U.S. Cl. CPC C08L 75/04; C08K 5/56; C08K 3/32; C08K 9/06; C08K 7/28; C08K 2003/327; C08L 2205/16

(57) ABSTRACT

A composition comprising a deformable tacky polyurethane polymer, which is the reaction product of: a polyisocyanate, a polyol and a mono-hydroxy tackifier; and one or more non-chromated corrosion inhibitors. In addition, compositions are provided comprising a deformable tacky polyurethane polymer, which is the reaction product of: a polyisocyanate, a polyol and a mono-hydroxy tackifier; one or more of: surface modified silica nanoparticles, glass bubbles and fiber filler particles; and one or more non-chromated corrosion inhibitors. In addition, a flexible gasketing tape is provided comprising a composition according to the present disclosure.

### CROSS REFERENCE TO RELATED APPLICATIONS

This application claims priority from U.S. Provisional Application Ser. No. 61/774850, filed 8 Mar. 2013, the disclosure of which is incorporated by reference in its/their entirety herein.

### FIELD OF THE DISCLOSURE

This disclosure relates to compositions that may be useful as non-chromated corrosion inhibiting flexible gasketing materials.

### BACKGROUND OF THE DISCLOSURE

Flexible gasketing materials are known for their applications on aircraft in order to seal voids between floorboards, access panels, exterior panels, fittings, fixtures such as antenna, and other openings and seams and their related structures. For example, in what is termed the “wet areas” of an aircraft, such as the galley and the toilets, gasketing materials prevent fluids from reaching critical areas and causing corrosion, electrical shorts or systems malfunctions by their presence. Furthermore, the aluminum alloys used in aircraft achieve their high strength to weight ratio by inclusion of such additional elements as copper, silicon, chromium, manganese, zinc and magnesium. Unfortunately, these elements make the high strength aluminum alloys more susceptible to corrosion than pure aluminum. In order to protect the high strength aluminum alloys, corrosion inhibitive compounds, typically hexavalent chromium compounds in a water or solvent-based carrier, are often applied. However, the toxicity and carcinogenic properties of chromium has caused federal agencies, such as the Occupational Safety and Health Administration (OSHA) and Environmental Safety and Occupational Health (ESOH) to impose severe restrictions on its use. Changing federal regulations therefore dictate the need for corrosion protection systems that are capable of meeting the new regulatory standards while still capable of delivering corrosion protection comparable to hexavalent-chromium based materials.

WO 2012/092119 (Johnson et al.), co-assigned with the present disclosure, discloses a flexible corrosion prevention gasketing material comprising a deformable tacky polyurethane polymer.

U.S. Pat. No. 7,662,312 (Sinko et al.) purports to disclose a non-chromated corrosion inhibitor composition.

U.S. Pat. No. 7,972,533 (Jaworowski et al.) purports to disclose a non-chromated corrosion inhibiting water-borne primer.

### SUMMARY OF THE DISCLOSURE

Briefly, the present invention provides a deformable tacky gasketing material comprising a non-chromated corrosion inhibitor (NCCI).

In one aspect, the present invention provides a deformable tacky gasketing material comprising a pigment grade non-chromated corrosion inhibitor. In another aspect, the present invention provides a non-chromated deformable tacky gasketing material comprising one or more of a pigment grade organo-zinc/phosphate/silicate, a pigment grade strontium aluminum polyphosphate and a pigment grade zinc aluminum polyphosphate.

In another aspect, the present invention provides a deformable tacky gasketing material comprising a non-chromated corrosion inhibitor, wherein the gasketing material is the reaction product of a polyisocyanate, a polyol, and a mono-hydroxy tackifier. In some embodiments, the mono-hydroxy tackifier is a compound which may be derived from resin. In some embodiments, the mono-hydroxy tackifier is a compound which may be derived from rosin. In some embodiments, the mono-hydroxy tackifier is a compound which may be derived from a resin acid. In some embodiments, the mono-hydroxy tackifier is a compound which is polycyclic. In some embodiments, the mono-hydroxy tackifier is a compound which is triycyclic. In some embodiments, the mono-hydroxy tackifier has a molecular weight of greater than 200. In some embodiments, the mono-hydroxy tackifier has a molecular weight of greater than 250. In some embodiments, the mono-hydroxy tackifier is hydroabietyl alcohol. In some embodiments, the polyisocyanate is a multifunctional polyisocyanate having a functionality of greater than 2. In some embodiments, the polyol has a molecular weight of greater than 500. In some embodiments, the polyol has a molecular weight of greater than 700. In some embodiments, the polyol is a hydroxyl-terminated polybutadiene.

In another aspect, the present invention provides compositions comprising a polymer and a non-chromated corrosion inhibitor according to the present invention, and one or more of: surface modified silica nanoparticles, glass bubbles and fiber filler particles.

### DETAILED DESCRIPTION

The present disclosure provides a non-chromated, low density, fire-retardant, flowable, polyurethane gel tape that is capable of sealing aircraft structures from a variety of fluids, and preventing corrosion through the various environments encountered on aircraft. The present disclosure additionally provides a two-part, reactive gel composition based on the same chemistry.

The gel-like tape herein may exhibit characteristics of being tacky, compressibly flowable, corrosion resistant, flame retardant, low in specific gravity (for weight savings), exhibiting no appreciable increase in adhesion over time, and having sufficient cohesive strength to be easily and cleanly removed from a solid substrate upon disassembly.

In some embodiments, the non-chromated corrosion inhibitor may be a solid, more preferably, a powder. In some embodiments, the non-chromated corrosion inhibitor may be selected to impart a particular color to the gel-like tape.

In some embodiments, the deformable polyurethane composition according to the present disclosure is produced from a reaction mixture including: a multi-functional isocyanate, a high molecular weight hydroxyl-terminated polybutadiene, a mono-hydroxy functional tackifier and a polyurethane catalyst. In some embodiments, the reaction mixture additionally includes a low molecular weight alcohol. In some embodiments, the reaction mixture additionally includes one or more of: inorganic fiber filler and chopped inorganic or organic random fibers. In some embodiments, the reaction mixture additionally includes one or more of: glass bubbles and surface modified nanoparticles. In some embodiments, the reaction mixture additionally includes a plasticizer. In some embodiments, the reaction mixture additionally includes an antioxidant.

In one embodiment, the non-chromated corrosion inhibiting deformable polyurethane composition according to the present disclosure includes: one or more pigment grade non-chromated corrosion inhibitors such as an organo-zinc/phosphate/silicate such as HYBRICOR 204 from WPC Technologies, Inc., Milwaukee, Wis., a strontium aluminum polyphosphate such as HEUCOPHOS SAPP and a zinc aluminum polyphosphate such as HEUCOPHOS ZAPP, both from Heubach GmbH, Langelsheim, Germany; a multi-functional isocyanate such as DESMODUR N3300 from Bayer Corp., a high molecular weight hydroxyl-terminated polybutadiene such as POLY BD R45HTLO from Sartomer Corp., a mono-hydroxy functional tackifier such as ABITOL E from Eastman Chemical Company, a low molecular weight alcohol such as 2-ethyl-1-hexanol from Alpha Aesar Company, dibutyl tin dilaurate polyurethane catalyst DABCO T-12 from Air Products, Inc., a phosphated plasticizer such as PHOSFLEX 31L from Supresta Company, glass bubbles from 3M Company, 5 nanometer surface modified nanoparticles, also from 3M Company, IRGANOX 1010 antioxidant from Ciba Corporation, and chopped inorganic or organic random fibers such as ⅛-inch (3 mm) chopped polyester fibers from William Barnett and Son, LLC.

Any suitable multi-functional isocyanate may be used. Examples include DESMODUR N3300 from Bayer Corp. The multi-functional isocyanate is used to produce a final crosslinked, thermoset polyurethane composition. Multi-functional means the isocyanate has on average more than two isocyanate groups per molecule. Some embodiment utilize di-isocyanates, which have a functionality of two lead to linear polyurethanes when reacted with diols, which also have a functionality of two. Some embodiments have an average functionality, between the isocyanate and polyol components, of greater than 2.0, leading to a crosslinked, thermoset polyurethane.

Any suitable polyol may be used. Examples include POLY BD R45HTLO from Sartomer Corp. In some embodiments, the polyol component of the polyurethane composition relies on a hydroxyl terminated polybutadiene which provides for a final composition with a very low glass transition temperature and insures that the adhesive characteristics of the composition are relatively uniform over a large range in temperature.

Any suitable tackifier may be used. Typically, the tackifier component is designed specifically to react into the polyurethane composition and simultaneously allow the total system functionality to be reduced. Being mono-functional serves to regulate the degree of polymerization of the composition and allow for an overall balance of properties. Other non-reactive tackifiers can also be utilized to strike a balance in adhesion performance.

In some embodiments, a low molecular weight mono-alcohol is also incorporated. This may serve a similar fashion as the reactive tackifier but avoids directly affecting the adhesive properties of the composition.

In some embodiments, a plasticizer is incorporated into the composition to strike a balance in the adhesive and mechanical properties of the sealant and also impart flame retardant characteristics to the composition.

In some embodiments, chopped organic and inorganic fibers are incorporated into the composition to improve the cohesive strength of the composition so that when end-of-life occurs for the sealant tape it can be easily removed. These fibers provide small scale reinforcement to the composition. These may be used in conjunction with chopped inorganic or organic fibers, which provide larger scale reinforcement to the composition. Each reinforcement when combined is capable of striking a cohesive balance to the polyurethane composition.

In some embodiments, glass bubbles are incorporated to reduce the specific gravity of the sealant for weight savings, which can be particularly beneficial in the aerospace industry.

In some embodiments, surface modified nanoparticles are incorporated into the composition as gas stabilizers for the purpose of frothing. Frothing provides additional weight savings and simultaneously enables the composition to be more rheologically responsive when the polyurethane gel tape is placed in compression.

In some embodiments, an antioxidant is incorporated into the composition to provide oxidative stability. In some embodiments, IRGANOX 1010 antioxidant is incorporated.

The polyurethane gel tape may be produced by any suitable method. In one embodiment, the polyurethane gel tape is produced by a process that relies on mixing the isocyanate and polyol and directly casting the composition between top and bottom process liners. In some embodiments, the liners are removed. In some embodiments, one liner is removed and the other is left as part of the product construction. In some embodiments, both liners are left as part of the product construction.

In some embodiments, the deformable polyurethane composition is a sheet, in some embodiments having a thickness of less than 10 mm, more typically less than 5 mm, and more typically less than 1 mm. Such a sheet typically has a thickness of at least 10 microns, more typically at least 20 microns, and more typically at least 30 microns. In some embodiments the sheet of deformable polyurethane forms a layer of a multi-layered structure, whose other layers are, in some embodiments, fluoropolymer sheets. In some embodiments the sheet of deformable polyurethane forms a layer of a two-layered structure, whose other layer is a fluoropolymer sheet. In some embodiments the sheet of deformable polyurethane forms a layer of a multi-layered structure, whose other layers are, in some embodiments, sheets of poly(ethylene-co-methacrylic acid) ionomer film. In some embodiments the sheet of deformable polyurethane forms a layer of a two-layered structure, whose other layer is a sheet of poly(ethylene-co-methacrylic acid) ionomer film.

Objects and advantages of this disclosure are further illustrated by the following examples, but the particular materials and amounts thereof recited in these examples, as well as other conditions and details, should not be construed to unduly limit this disclosure.

### EXAMPLES

Unless otherwise noted, all reagents were obtained or are available from Aldrich Chemical Co., Milwaukee, Wis., or may be synthesized by known methods.

The following abbreviations are used to describe the examples:
° C.: degrees Centigrade
° F.: degrees Fahrenheit
cm: centimeters
g/cm.w grams per centimeter width
kg: kilogram
lb: pound
mil: 10⁻³ inches
mm: millimeters
m: micrometers
oz/in.w ounces per inch width
rpm: revolutions per minute

Materials Used:

ABITOL-E: A monohydroxy functional hydroabietyl alcohol tackifier, obtained under the trade designation “ABITOL E” from Eastman Chemical Company, Kingsport, Tenn.

CPF: 0.118-inch (3.0 mm), 1.5 denier chopped uncrimped polyester fiber, obtained from William Barnet and Son, LLC, from Arcadia, S.C.

DESMODUR: A multifunctional isocyanate obtained under the trade designation “DESMODUR N3300A” from Bayer MaterialScience, LLC, Pittsburgh, Pa.

DBTDL: Dibutyltin dilaurate, obtained under the trade designation “DABCO T-12” from Air Products & Chemicals, Inc., Allentown, Pa.

IOTMS: Isooctyltrimethoxysilane, obtained from Gelest, Inc., Morrisville, Pa.

IRGANOX: Pentaerythritol tetrakis(3-(3,5-di-tert-butyl-4-hydroxyphenyl)propionate), obtained under the trade designation “IRGANOX 1010” from BASF Corporation, Florham Park, N. J.

K1 -GB: Glass bubbles, obtained under the trade designation “K1 GLASS BUBBLES” from 3M Company, St. Paul, Minn.

MTMS: Methyltrimethoxysilane, obtained from Gelest, Inc.

N2326: An aqueous 5 nm colloidal silica dispersion, 16.06% solids, obtained under the trade designation “N2326” from Nalco, Naperville, Ill.

NCCI-1: A pigment grade organo-zinc/phosphate/silicate corrosion inhibitor, obtained under the trade designation “HYBRICOR 204” from WPC Technologies, Inc., Milwaukee, Wis.

NCCI-2: A pigment grade strontium aluminum polyphosphate corrosion inhibitor, obtained under the trade designation “HEUCOPHOS SAPP” from Heubach GmbH, Langelsheim, Germany.

NCCI-3: A pigment grade zinc aluminum polyphosphate corrosion inhibitor, obtained under the trade designation “HEUCOPHOS ZAPP” from Heubach GmbH.

OOD: 1-Octadecanol.

PHOSFLEX: A substituted triaryl phosphate ester plasticizer, obtained under the trade designation “PHOSFLEX 31L” from ICL Industrial Products, Tel Aviv, Israel.

POLY-BD: A hydroxyl terminated polybutadiene resin, obtained under the trade designation “POLY BD R-45HTLO” from Sartomer Company, Inc., Exton, Pa.

POLYESTER 74A: A silicone treated 2 mil (50.8 m) polyester film, obtained under the trade designation “SILPHAN S50 M&$A” from Siliconature USA, LLC, Chicago, Ill.

SMSN: 85:15 weight percent isooctyltrimethoxysilane:methylmethoxysilane modified 5 nm silica nanoparticles, synthesized as follows. 100 grams Nalco 2326 colloidal silica, 7.54 grams of IOTMS, 0.81 grams of MTMS and 112.5 grams of an 80:20 weight percent blend of ethanol:methanol were added to a 500 ml 3 -neck round bottom flask equipped with a stirring assembly, thermometer and condenser. The flask was placed in an oil bath set at 80° C. and stirred for 4 hours, after which the mixture was transferred to a crystallizing dish and dried in a convection oven set at 150° C. for 2 hours.

SMSN-PFX: A 10% by weight dispersion of SMSN in PHOSFLEX.

TEH: 2-Ethyl-1-hexanol, obtained from Alfa Aesar Company, Ward Hill, Mass.

### Comparative A

Except where noted, the following components were pre-heated to 158° F. (70° C.) prior to addition: 2.07 grams TEH was added to a mixing cup, type “MAX 100”, obtained from Flacktek, Inc., Landrum, S.C. 20.31 grams POLY-BD, degassed under vacuum for 180 minutes at 140° F. (60° C.) in an oven, model “ADP21” from Yamato Scientific America, Inc., Santa Clara, Calif., was added to the mixing cup, followed by 4.75 grams SMSN-PHX, 18.00 grams PHOSFLEX and 11.52 grams ABITOL-E. The cup was placed in an oven, model “RE-53” from Binder GmbH, Tuttlingen, Germany, set at 158° F. (70° C.), for 30 minutes. The cup was removed from the oven and the mixture blended until homogeneous by slowly stirring for 2 minutes with an air-driven mixer, model “1AM-NCC-12”, obtained from Gast Manufacturing, Inc., Benton Harbor, Mich. 51.50 grams of this pre-blend mixture was then transferred to another MAX 100 mixing cup, followed by 1.28 grams IRGANOX, 2.00 grams K1-GB and 3.50 grams CPF, after which the mixture was returned to the oven for another 30 minutes at 158° F. (70° C.). Upon removal from the oven the cup was then placed in a mixer, model number DAC 150 FV-FVZ, obtained from Flactek, and the mixture blended at 3,540 rpm for one minute, until homogeneous. The cup was then returned to the oven for another 30 minutes, after which it was removed and 10.30 grams DESMODUR was added to the composition, followed by, drop wise, 0.09 grams DBTDL. The cup was returned to the mixer and blended for one minute at 3,540 rpm for one minute, until homogeneous.

The composition was coated between two 2-mil (50.4 m) silicone coated polyester release liners using a laboratory roll coater, at a nominal gap of 35 mils (0.89 mm) The coating was cured at 158° F. (70.0° C.) for 1.5 hours, resulting in a gel tape having a film thickness of approximately 45 mils (1.14 mm)

### Example 1

The general procedure as described in Comparative A was repeated, wherein the composition was modified as follows: 0.23 grams OOD were added to a “MAX 100” mixing cup. 20.31 grams POLY-BD, degassed under vacuum for 180 minutes at 140° F. (60° C.) in the ADP21 oven, was added to the mixing cup, followed by 22.29 grams PHOSFLEX. 2.07 grams TEH was then slowly added, drop wise, to the mixture, followed by 13.93 grams ABITOL-E and 3.0 grams NCCI-1, after which the cup was placed in the RE-53 oven set at 158° F. (70° C.) until the composition had melted, approximately 30 minutes. The cup was placed on the hotplate, set to 200° F. (93.3° C.), and the mixture blended until homogeneous by stirring for 4 minutes with the air-driven mixer. 56.48 grams of this pre-blend mixture was then transferred to another MAX 100 mixing cup, followed by 1.28 grams IRGANOX, 2.00 grams K1-GB and 3.50 grams CPF, after which the mixture was returned to the oven set at 158° F. (70° C.) for 30 minutes. Upon removal from the oven the mixture blended until homogeneous in the Flactek mixer for one minute at 3,540 rpm, then returned to the oven for another 30 minutes at 158° F. (70° C.). The cup was removed from the oven and 11.05 grams DESMODUR was added to the composition, followed by, drop wise, 0.09 grams DBTDL. The cup was returned to the mixer and blended for one minute at 3,540 rpm for one minute, until homogeneous. A gel tape was then prepared according to the method described in Comparative A.

### Example 2

The general procedure as described in Example 1 was repeated, wherein the composition was modified as follows: 0.23 grams OOD were added to a “MAX 100” mixing cup. 20.31 grams POLY-BD, degassed under vacuum for 180 minutes at 140° F. (60° C.) in the ADP21 oven, was added to the mixing cup, followed by 18.00 grams PHOSFLEX and 4.75 grams SMSN-PHX. 2.07 grams TEH was then slowly added, drop wise, to the mixture, followed by 12.67 grams ABITOL-E 3.0 grams NCCI-1, and the cup placed in the RE-53 oven set at 158° F. (70° C.) until the composition had melted, approximately 30 minutes. The cup was placed on the hotplate, set to 200° F. (93.3° C.), and the mixture blended until homogeneous by stirring for 4 minutes with the air-driven mixer. 55.76 grams of this pre-blend mixture was then transferred to another MAX 100 mixing cup, followed by 1.28 grams IRGANOX, 2.00 grams K1-GB and 3.50 grams CPF, after which the mixture was returned to the oven set at 158° F. (70° C.) for 30 minutes. Upon removal from the oven the mixture blended until homogeneous in the Flactek mixer for one minute at 3,540 rpm, then returned to the oven for another 30 minutes at 158° F. (70° C.). The cup was removed from the oven and 11.05 grams DESMODUR was added to the composition, followed by, drop wise, 0.09 grams DBTDL. The cup was returned to the mixer and blended for one minute at 3,540 rpm for one minute, until homogeneous. A gel tape was then prepared according to the method described in Comparative A.

### Example 3

The general procedure as described in Example 2 was repeated, wherein the K1-GB was increased from 2.00 to 5.00 grams, incorporated by means of the Flactek mixer at 3,500 rpm for 1 minute, and the NCCI was a blend of 3.38 grams NCCI-2 and 0.85 grams NCCI-3, of which 3.85 grams of the blend was added to the pre-mix. A gel tape was then prepared according to the method described in Comparative A.

The compositions of the Comparative and the Examples, adjusted for the pre-blend, are summarized as weight percent in Table 1.

TABLE 1

| Component (Wt. %) | Comparative A | Example 1 | Example 2 | Example 3 |
|---|---|---|---|---|
| ABITOL-E | 10.47 | 12.67 | 11.52 | 11.52 |
| CPF | 3.50 | 3.50 | 3.50 | 3.50 |
| DBTDL | 0.09 | 0.09 | 0.09 | 0.09 |
| DESMODUR | 10.30 | 10.30 | 11.05 | 11.05 |
| IRGANOX | 1.28 | 1.28 | 1.28 | 1.28 |
| K1-GB | 2.00 | 2.00 | 2.00 | 5.00 |
| NCCI-1 | 0 | 2.73 | 2.73 | 0 |
| NCCI-2 | 0 | 0 | 0 | 3.08 |
| NCCI-3 | 0 | 0 | 0 | 0.77 |
| OOD | 0 | 0.21 | 0.21 | 0.21 |
| PHOSFLEX | 16.37 | 20.26 | 16.37 | 16.37 |
| POLY-BD | 18.46 | 18.46 | 18.46 | 18.46 |
| SMSN-PFX | 4.32 | 0 | 4.32 | 4.32 |
| TEH | 1.88 | 1.88 | 1.88 | 1.88 |

### Test Methods

The examples of gel tape were evaluated according to the test methods described below, the results of which are listed in Table 2.

### Room Temperature Peel Strength.

A 2 by 5 inch by 43.2 mil (50.8 by 127.0 cm by 1.1 mm), stainless steel test coupon, obtained from Cheminstruments, Inc., Fairfield, Ohio. The exposed face of the coupon was wiped with isopropyl alcohol and allowed to dry. The liner was removed from one side of the gel tape example and the exposed face of the gel tape manually laminated over the cleaned surface of the stainless steel coupon using the 4.5 lb (2.04 kg) weighted roller, also obtained from Cheminstruments, Inc. The test sample was then held at 70° F. (21.2° C.) for 24 hours before measuring the peel strength according to ASTM D3330.

### Salt Corrosion Resistance Test.

A 4 by 7 inch by 63 mil coupon of (10.16 by 17.78 cm by 1.6 mm) unclad 7075T6 grade aluminum was cleaned with isopropyl alcohol and allowed to dry at 70° F. (21.1° C.). A 2 by 2 inch (5.08 by 5.08 cm) section of gel tape was manually secured to one side of the coupon using a 4 pound (1.82 kg) roller and the sample held at 70° F. (21.1° C.) for 18 hours. The test coupon was then sprayed with approximately 3.3 grams of a 5% by weight aqueous solution of sodium chloride and transferred to a desiccator maintained at 95° F. (35° C.) and 95% relative humidity for 4 hours. The sample was removed from the desiccator and the approximately 3.3 grams of salt spray reapplied twice more at 4 hour intervals, after which the test coupon was held for 16 hours in the desiccator. This salt spray regimen was then repeated 4 more times, for a total of 5 consecutive days, after which the test coupon then held in the desiccator for another 48 hours, for a combined test time of 168 hours. This process was repeated 3 more times, resulting in a total of 60 salt spray applications over a 28-day period. The gel tape was then removed from the coupon, the coupon cleaned with isopropyl alcohol and allowed to dry at 70° F. (21.1° C.).

The degree of coupon corrosion underlying the gel tape was subjectively evaluated on a scale of 1-5, according to the following criteria:

| % of Test Area Corroded | Rating |
|---|---|
| 0-5 | 1 |
| 6-10 | 2 |
| 11-15 | 3 |
| 16-20 | 4 |
| 20-25 | 5 |

Results are listed in Table 2.

TABLE 2

| | Peel Strength | Salt Corrosion |
|---|---|---|
| Sample | oz/in · w (g/cm · w) | Resistance Test Rating |
| Comparative A | 8.0 (89.3) | 4 |
| Example 1 | 7.7 (85.9) | 1 |
| Example 2 | 24.8 (276.8) | 1 |
| Example 3 | 9.6 (107.2) | 1 |

Various modifications and alterations of this disclosure will become apparent to those skilled in the art without departing from the scope and principles of this disclosure, and it should be understood that this disclosure is not to be unduly limited to the illustrative embodiments set forth hereinabove.

1. A composition comprising:
a deformable tacky polyurethane polymer which is the reaction product of a polyisocyanate, a polyol and a mono-hydroxy tackifier; and
a non-chromated corrosion inhibitor.

2. The composition according to claim 1, wherein the non-chromated corrosion inhibitor is an organo-zinc/phosphate/silicate.

3. The composition according to claim 1, wherein the non-chromated corrosion inhibitor is a strontium aluminum polyphosphate.

4. The composition according to claim 1, wherein the non-chromated corrosion inhibitor is a zinc aluminum polyphosphate.

5. A composition comprising:
a deformable tacky polyurethane polymer which is the reaction product of a polyisocyanate, a polyol and a mono-hydroxy tackifier; and
two or more non-chromated corrosion inhibitors selected from the group:
an organo-zinc/phosphate/silicate;
a strontium aluminum polyphosphate
a zinc aluminum polyphosphate.

6. The composition according to claim 1, wherein the mono-hydroxy tackifier is a compound which may be derived from resin.

7. The composition according to claim 1, wherein the mono-hydroxy tackifier is a compound which may be derived from rosin.

8. The composition according to claim 1, wherein the mono-hydroxy tackifier is a compound which may be derived from a resin acid.

9. The composition according to claim 1, wherein the mono-hydroxy tackifier is a compound which is polycyclic.

10. The composition according to claim 1, wherein the mono-hydroxy tackifier is a compound which is tricyclic.

11. The composition according to claim 1, wherein the mono-hydroxy tackifier has a molecular weight of greater than 200.

12. The composition according to claim 1, wherein the mono-hydroxy tackifier has a molecular weight of greater than 250.

13. The composition according to claim 1, wherein the mono-hydroxy tackifier is hydroabietyl alcohol.

14. The composition according to claim 1, wherein the polyisocyanate is a multifunctional polyisocyanate having a functionality of greater than 2.

15. The composition according to claim 1, wherein the polyol has a molecular weight of greater than 500.

16. The composition according to claim 1, wherein the polyol has a molecular weight of greater than 700.

17. The composition according to claim 1, wherein the polyol is a hydroxyl-terminated polybutadiene.

18. The composition according to claim 1, wherein the deformable tacky polyurethane polymer further comprises surface modified silica nanoparticles.

19. The composition according to claim 1, wherein the deformable tacky polyurethane polymer further comprises glass bubbles.

20. The composition according to claim 1, wherein the deformable tacky polyurethane polymer further comprises fiber filler particles.

21. The composition according to claim 1, wherein the deformable tacky polyurethane polymer further comprises surface modified silica nanoparticles, glass bubbles and fiber filler particles.

22. A flexible gasketing tape comprising the composition of claim 1, having a thickness of greater than 0.5 mm and less than 5 mm.
